(19) United States
(12) Patent Application Publication
(10) Pub. No.: US 2010/0048125 A1
(43) Pub. Date: Feb. 25, 2010

(54) Electronic Device and Computer Product

(75) Inventor: Hideki Ohkita, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/415,560

(22) Filed: Mar. 31, 2009

(30) Foreign Application Priority Data
Aug. 25, 2008 (JP) 2008-215977

(51) Int. Cl. H04B 5/00

(52) U.S. Cl. 455/41.1

(57) ABSTRACT

According to one embodiment, an electronic device includes a near field wireless communication device, a communication module, a connection processor, a timer, an execution module, a log storage module, and a process selector. The communication module controls the near field wireless communication device for near field wireless communication. The connection processor establishes a connection to a correspondent electronic device. The timer records the time related to operations. The execution module executes applications. The log storage module stores as log data a log of execution of an application with the time the application is executed. The process selector acquires at least one of the log data stored in the log storage module and log data of the correspondent electronic device, and selects an application to execute based on the log data to notify the execution module of the application.

### CROSS-REFERENCE TO RELATED APPLICATIONS

This application is based upon and claims the benefit of priority from Japanese Patent Application No. 2008-215977, filed Aug. 25, 2008, the entire contents of which are incorporated herein by reference.

### BACKGROUND

1. Field

One embodiment of the invention relates to an electronic device and a computer product employing a close proximity wireless transfer technology.

2. Description of the Related Art

Non-contact near field communication systems using an integrated circuit (IC) card has been widely used. Such a near field communication system generally uses an electromagnetic induction method in which, when an IC card is passed over a card reader/writer, an alternating magnetic field generated by the card reader/writer induces an alternating magnetic field in the antenna coil of the IC card, thereby causing the IC chip thereof to operate (see, for example, Japanese Patent Application Publication (KOKAI) No. 2007-183780). In addition to the power supply by the induced magnetic field, data exchange is possible between the IC chip and the card reader/writer.

Besides, close proximity wireless transfer technologies, such as TransferJet, have recently been developed that allow wireless data transfer between devices by only bringing them close together. Such a close proximity wireless transfer technology affords high-speed transfer of large-volume data between, for example, a portable electronic device, such as a mobile phone, a digital camera and a portable audio player, and a personal computer (PC) by only passing the portable electronic device over the PC. Since this intuitive operation of passing a device over a reader is easy for users, the close proximity wireless transfer technology is expected to be widespread.

In the close proximity wireless transfer technologies such as TransferJet as described above, a user is required to select an application or a content to execute before bringing the devices close together. In other words, the overall operation related to data transfer does not complete by only the intuitive operation of passing one device over the other. That is, there is still room for improvement in operability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a near field wireless communication system according to a first embodiment of the invention;

FIG. 2 is an exemplary block diagram of electronic devices in the near field wireless communication system in the first embodiment;

FIG. 3 is an exemplary block diagram of a configuration implemented by a near field wireless communication control program in the first embodiment;

FIG. 4 is an exemplary schematic diagram of a log table in the first embodiment;

FIG. 5 is an exemplary schematic diagram of an application association table in the first embodiment;

FIG. 6 is an exemplary schematic diagram for explaining a near field wireless communication control process in the first embodiment;

FIG. 7 is an exemplary schematic sequence diagram of the near field wireless communication control process in the first embodiment;

FIG. 8 is an exemplary flowchart of a log data storage process in the first embodiment;

FIG. 9 is an exemplary flowchart of an application selection process performed on a PC in the first embodiment;

FIG. 10 is an exemplary flowchart of an application selection process performed on a mobile phone in the first embodiment;

FIG. 11 is another exemplary schematic diagram for explaining the near field wireless communication control process in the first embodiment;

FIG. 12 is another exemplary schematic sequence diagram of the near field wireless communication control process in the first embodiment;

FIG. 13 is an exemplary flowchart of an application invoking process according to a second embodiment of the invention;

FIG. 14 is an exemplary schematic diagram for explaining the application invoking process in the second embodiment; and

FIG. 15 is another exemplary schematic diagram for explaining the application invoking process in the second embodiment.

### DETAILED DESCRIPTION

Various embodiments according to the invention will be described hereinafter with reference to the accompanying drawings. In general, according to one embodiment of the invention, an electronic device comprises: a near field wireless communication device; a communication module configured to control the near field wireless communication device to perform near field wireless communication; a connection processor configured to establish a connection to a correspondent electronic device through the communication module; a timer configured to record time related to execution of operations; an execution module configured to invoke and execute applications; a log storage module configured to store, when the execution module executes one of the applications, a log of execution of the application with execution time the application is executed specified by the timer as first log data; and a process selector configured to acquire, when the connection processor establishes a connection to a correspondent electronic device through the communication module, at least one of the first log data stored in the log storage module and second log data of the correspondent electronic device, selects one of the applications to execute after establishment of the connection based on at least one of the first log data and the second log data acquired, and notifies the execution module of the application.

According to another embodiment of the invention, a computer program product is embodied on a computer-readable medium and comprises codes that, when executed on a computer, causes the computer to perform: performing near field wireless communication; establishing a connection to a correspondent electronic device; recording time related to execution of operations; invoking and executing applications; storing, when one of the applications is executed, a log of execution of the application with execution time the application is executed recorded at the recording as log data; acquiring, when a connection to a correspondent electronic device is established, at least one of the log data stored at the storing and log data of the correspondent electronic device; and selecting one of the applications to execute after establishment of the connection based on the log data acquired.

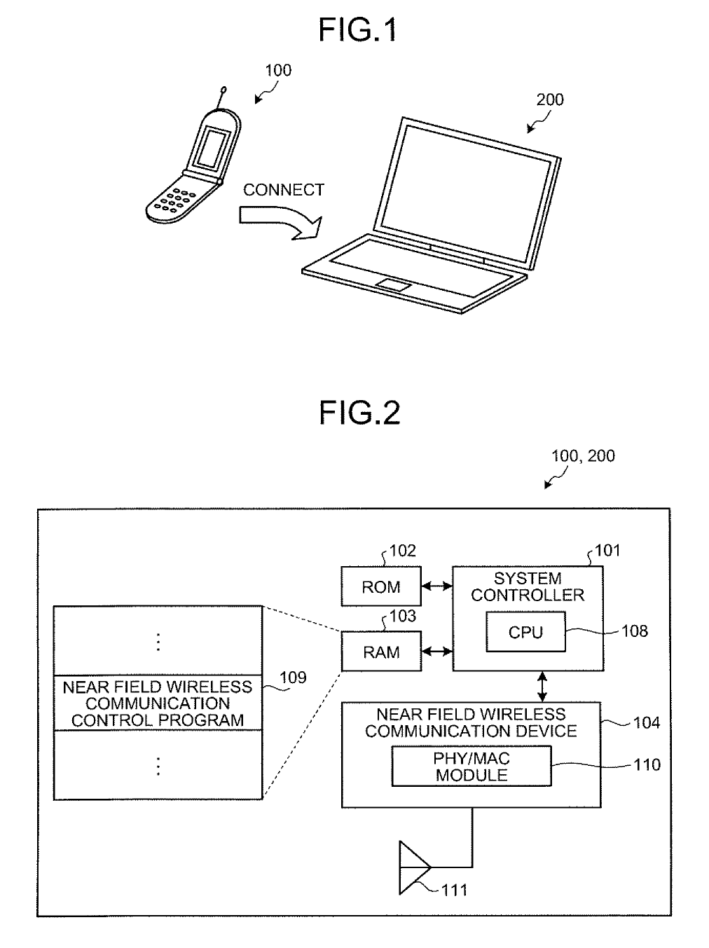

A first embodiment of the invention will be described with reference to FIGS. 1 to 12. While electronic devices in a near field wireless communication system are described below as a mobile phone and a personal computer (PC), this is by way of example only. Examples of the electronic devices include portable mobile terminals such as PDA and consumer devices such as televisions and audio players.

FIG. 1 is a schematic diagram of a near field wireless communication system according to the first embodiment. As illustrated in FIG. 1, in the near field wireless communication system, when a user brings a mobile phone 100 close to a PC 200, i.e., passes the mobile phone 100 over the PC 200, the mobile phone 100 and the PC 200 can communicate with each other.

FIG. 2 is a block diagram of the electronic devices in the near field wireless communication system. As illustrated in FIG. 2, the mobile phone 100 and the PC 200, cited herein as examples of the electronic device of the near field wireless communication system, comprises a system controller 101, a read only memory (ROM) 102, a random access memory (RM) 103, and a near field wireless communication device 104.

The system controller 101 controls the operation of each module in the electronic device. The system controller 101 comprises a central processing unit (CPU) 108, and is connected to the RON 102, the RAM 103, and the near field wireless communication device 104.

The ROM 102 stores programs and various types of data necessary for control purposes, and the CPU 108 loads them into the RAM 103 to perform required processing. A computer program (hereinafter, “near field wireless communication control program”) 109 is loaded into the RAM 103. The CPU 108 executes the near field wireless communication control program 109 to control the near field wireless communication device 104.

As illustrated in FIG. 2, the near field wireless communication device 104 comprises a PHY/MAC module 110 and an antenna 111. The PHY/MAC module 110 operates under the control of the CPU 108 according to the near field wireless communication control program 109. The PRY/MAC module 110 communicates with other electronic devices having a near field wireless communication function via the antenna 111. The antenna 111 transmits/receives data to/from other electronic devices by a signal using an induced magnetic field.

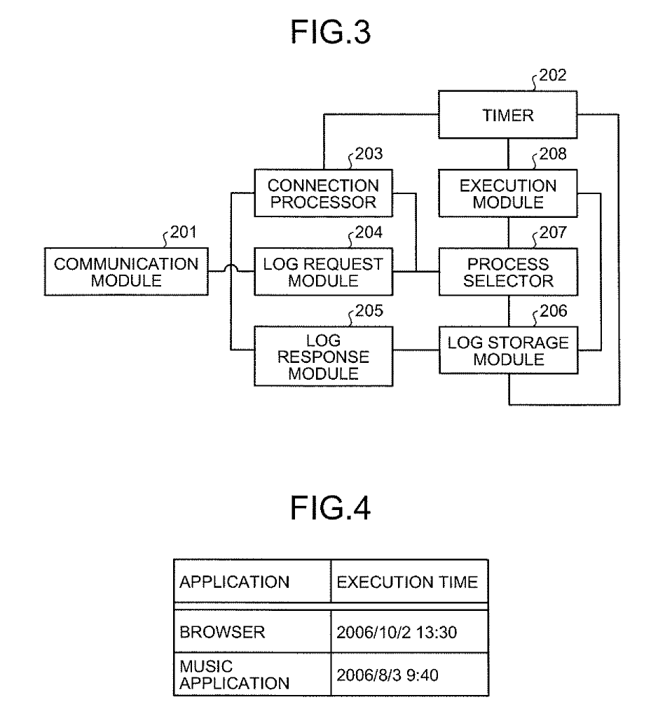

FIG. 3 is a block diagram of a configuration implemented by the near field wireless communication control program 109. As illustrated in FIG. 3, the near field wireless communication control program 109 implements, when executed by the CPU 108, a communication module 201, a timer 202, a connection processor 203, a log request module 204, a log response module 205, a log storage module 206, a process selector 207, and an execution module 208.

The communication module 201 controls the PHY/MAC module 110 of the near field wireless communication device 104 to perform near field wireless communication which is a type of near field communication (NEC). The near field wireless communication device 104 performs the near field wireless communication with another near field wireless communication device in a peer-to-peer manner. The near field wireless communication is possible over a distance of, for example, about three centimeters. In other words, a wireless connection is established between the near field wireless communication device 104 and another near field wireless communication device only when they come close within a predetermined distance (e.g., 3 cm). The near field wireless communication may be implemented with “TransferJet” that enables communication using an induced magnetic field. “TransferJet” is a close proximity wireless transfer technology using a ultra wide band (UWB) and allows high-speed wireless data transfer.

The connection processor 203 establishes a connection to another device as a correspondent device through the communication module 201. In the near field wireless communication system, connection mode includes initiator mode and responder mode. A device operating in the initiator mode, i.e., an initiator, functions as a master device, and sends a connection request to another device. On the other hand, a device operating in the responder mode, i.e., a responder, functions as a slave device, and detects the connection request sent from the master device. When the initiator and the responder are brought close together, a connection is established between them. Meanwhile, if a couple of initiators are brought close together, no connection is established between them. The same applies to a couple of responders. Therefore, for data transfer between devices through near field wireless communication, a user is required to set the devices in appropriate connection mode.

The timer 202 counts or records the time related to various types of processing. The execution module 208 invokes various applications and executes them.

The log storage module 206 stores as log data, when an application is executed by the execution module 208, a log of the execution of the application (hereinafter, “application execution log”) together with the execution time at which the application is executed specified by the timer 202. In addition, the log storage module 206 stores as log data, when the connection processor 203 establishes a connection to an electronic device as a correspondent device through the communication module 201, a log of the establishment of the connection (hereinafter, “connection log”) together with the connection time at which the connection is established specified by the timer 202.

FIG. 4 is a schematic diagram of an example of a log table stored in the log storage module 206. As the log data, the log table contains a list of applications log data of which are stored, among applications available on the mobile phone 100 and the PC 200, each with the last operation time thereof. Note that FIG. 4 illustrates an example of the log table, and the structure, content, etc. of the log table is not limited to this example.

The log request module 204 requests an electronic device as a correspondent device for the log data. The log response module 205 retrieves, upon receipt of a request for the log data from an electronic device as a correspondent device, the log data from the log storage module 206 and returns it to the correspondent electronic device in response to the request through the communication module 201.

The process selector 207 receives, when the connection processor 203 establishes a connection to a correspondent electronic device through the communication module 201, information on the event from the connection processor 203. The process selector 207 also retrieves its log data including the application execution log and the connection log from the log storage module 206. In addition, the process selector 207 receives, when the connection processor 203 establishes the connection to the correspondent electronic device through the communication module 201, the log data of the correspondent electronic device through the communication module 201 and the log request module 204. The process selector 207 selects an application to execute after the establishment of the connection based on the log data thereof and that of the correspondent electronic device, and notifies the execution module 208 of the application.

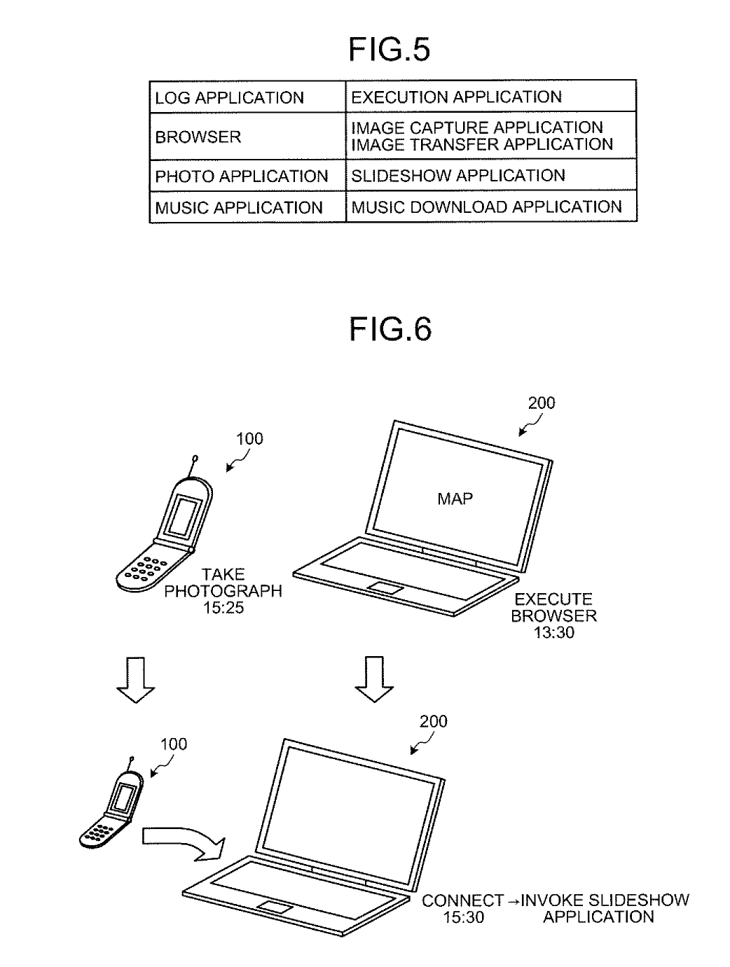

FIG. 5 is a schematic diagram of an example of an application association table managed by the process selector 207. The application association table contains an application (log application) whose execution log is monitored in association with an application (execution application) that is invoked in response to the establishment of a connection when the log application has been selected or executed. Note that FIG. 5 illustrates an example of the application association table, and the structure, content, etc. of the application association table is not limited to this example.

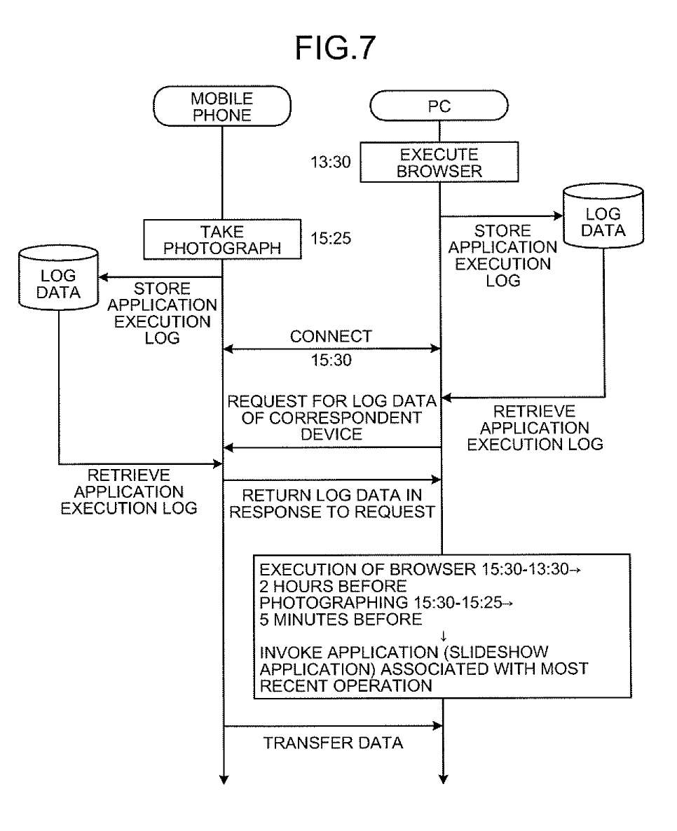

A description will be given of a near field wireless communication control process with a specific example. In the example of FIGS. 6 and 7, the PC 200 functions as an initiator, while the mobile phone 100 functions as a responder.

In the example of FIGS. 6 and 7, on the PC 200, i.e., an initiator, a browser is executed at 13:30. On the other hand, a user takes a photograph with the mobile phone 100, i.e., a responder, at 15:25. After that, the user passes the mobile phone 100 over the PC 200 so that they come close within a predetermined distance (e.g., 3 cm) at 15:30, and a connection is established between the mobile phone 100 and the PC 200 for near field wireless communication.

As illustrated in FIG. 7, when the browser is executed on the PC 200 at 13:30, the log storage module 206 of the PC 200 stores the application execution log with the time at which the application is executed specified by the timer 202. On the other hand, when the user takes the photograph with the mobile phone 100 at 15:25, the log storage module 206 of the mobile phone 100 stores the application execution log with the time at which the application is executed specified by the timer 202. Thereafter, when the connection is established between the mobile phone 100 and the PC 200 for near field wireless communication at 15:30 through the communication module 201 and the connection processor 203, in the PC 200 as an initiator, the process selector 207 retrieves the log data from the log storage module 206, and the log request module 204 requests the mobile phone 100 as a responder for its log data.

In the mobile phone 100 as a responder, in response to the request for the log data received from the PC 200 as an initiator, the log response module 205 retrieves the log data from the log storage module 206, and responds to the PC 200 through the communication module 201.

In the PC 200 as an initiator, when acquiring the log data thereof and that of the mobile phone 100 as a responder, the process selector 207 selects an application to execute after the establishment of the connection based on the sets of the log data, and notifies the execution module 208 of the application. It is herein assumed that an application corresponding to the most recent log entry is selected. Specifically, the user takes the photograph with the mobile phone 100 (five minutes before the establishment of the connection) more recently than the execution of the browser on the PC 200 (two hours before the establishment of the connection). Thus, the process selector 207 selects, from the application association table illustrated in FIG. 5, an execution application associated with a photo application, i.e., a slideshow application, and notifies the execution module 208 of the slideshow application.

Upon notified of the slideshow application by the process selector 207, the execution module 208 invokes the slideshow application.

In this manner, when a connection is established between the mobile phone 100 and the PC 200 for near field wireless communication after photographing with the mobile phone 100, an execution application associated with the photo application, i.e., the slideshow application, is invoked on the PC 200. The PC 200 receives an image taken by the mobile phone 100 and transferred therefrom. Thus, the user can view a slideshow of the image on the PC 200.

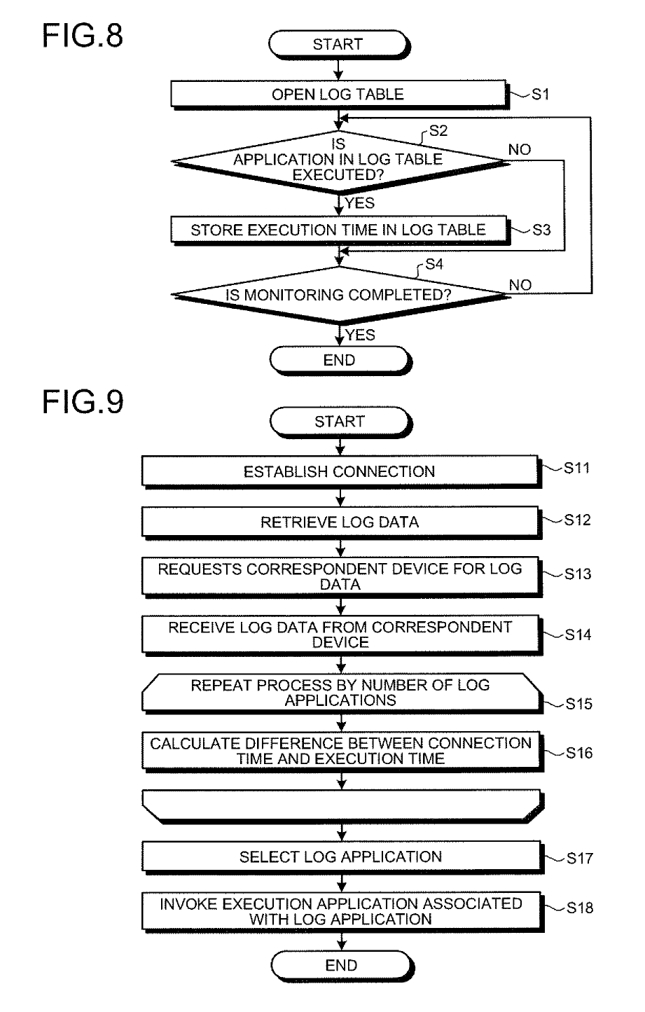

The above process will be described in detail below. FIG. 8 is a flowchart of a log data storage process performed by the log storage module 206.

First, the log storage module 206 opens the log table (S1), and monitors whether an application listed in the log table is executed (S2). Upon determining that an application in the log table is executed (Yes at (S2), the log storage module 206 stores the execution time at which the application is executed specified by the timer 202 in the log table (S3). Then, the process moves to S4.

On the other hand, upon determining that no application in the log table is executed (No at S2), the process directly moves to S4.

The process from S2 to S3 are repeated until the monitoring is completed (Yes at S4).

FIG. 9 is a flowchart of an application selection process performed by the PC 200 as an initiator. As illustrated in FIG. 9, when a connection to the mobile phone 100 is established for near field wireless communication (S11), the process selector 207 of the PC 200 retrieves the log data from the log storage module 206 (S12), and the log request module 204 requests the mobile phone 100 as a responder for its log data (S13).

After receipt of the log data from the mobile phone 100 (S14), the above process is repeated by the number of logs of the PC 200 as well as by the number of logs of the mobile phone 100 (S15). Then, the process selector 207 calculates the difference between the connection time and the execution time (S16) for each log.

The process selector 207 selects, based on the logs, an execution application associated with a log application with the smallest difference between the connection time and the execution time (S17), and notifies the execution module 208 of the execution application thus selected.

The execution module 208 invokes the execution application associated with the log application (S18).

While the execution application is described above as being selected based on both its own log data and that of a correspondent electronic device, this is by way of example and not of limitation. For example, the electronic device may select the execution application based only on its own log data without acquiring the log data of a correspondent electronic device. On the contrary, the electronic device may select the execution application based only on the log data of a correspondent electronic device without retrieving its own log data.

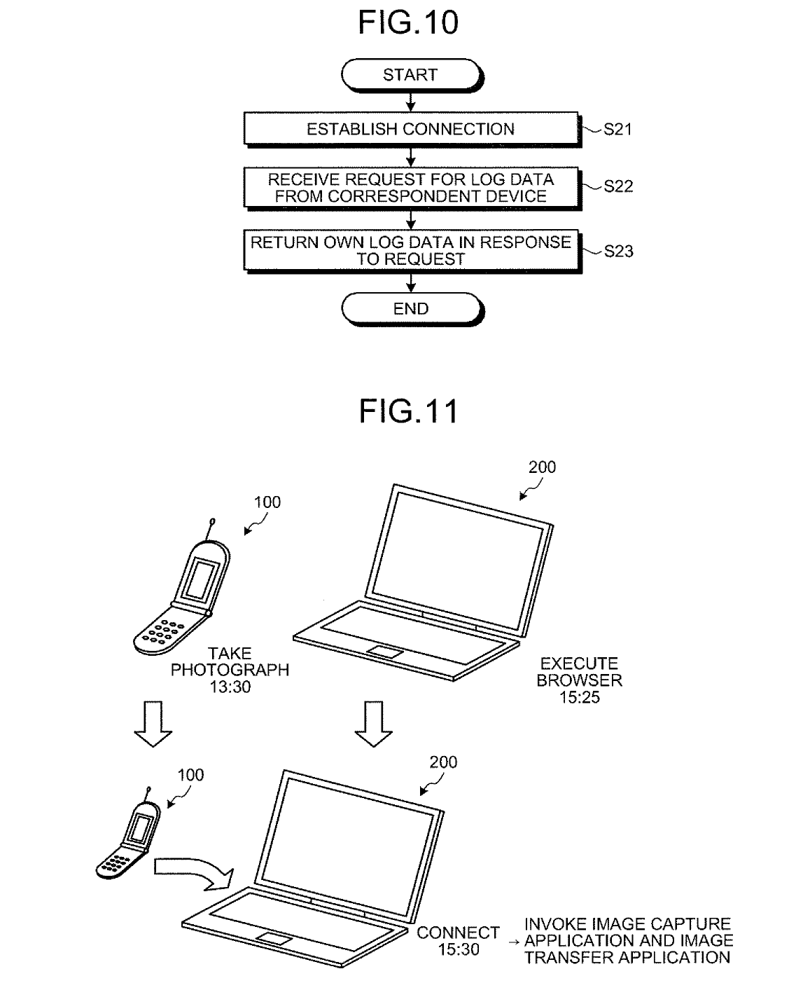

FIG. 10 is a flowchart of an application selection process performed on the mobile phone 100 as a responder. As illustrated in FIG. 10, after a connection to the PC 200 is established for near field wireless communication (S21), upon receipt of a request for the log data from the PC 200 as an initiator (S22), the log response module 205 of the mobile phone 100 retrieves the log data from the log storage module 206, and responds to the PC 200 through the communication module 201 (S23).

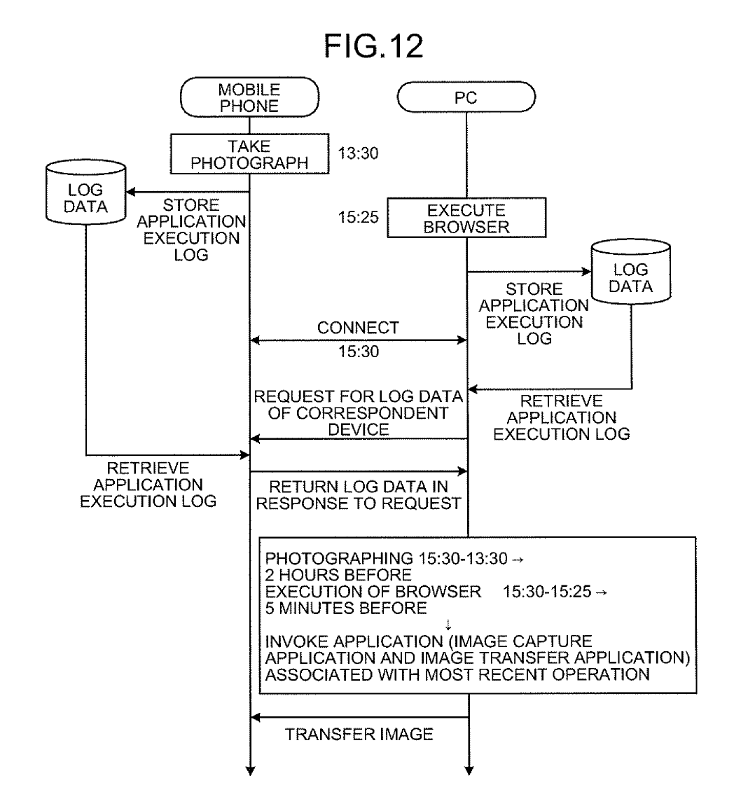

A description will be given of the near field wireless communication control process with another specific example. In the example of FIGS. 11 and 12, the PC 200 functions as an initiator, while the mobile phone 100 functions as a responder.

In the example of FIGS. 11 and 12, on the PC 200, i.e., an initiator, a browser is executed at 15:25. On the other hand, a user takes a photograph with the mobile phone 100, i.e., a responder, at 13:30. After that, the user passes the mobile phone 100 over the PC 200 so that they come close within a predetermined distance (e.g., 3 cm) at 15:30, and a connection is established between the mobile phone 100 and the PC 200 for near field wireless communication.

As illustrated in FIG. 12, when the browser is executed, for example, to display the map of an outside location on the PC 200 at 15:25, the log storage module 206 of the PC 200 stores the application execution log with the time at which the application is executed specified by the timer 202. On the other hand, when the user takes the photograph with the mobile phone 100 at 13:30, the log storage module 206 of the mobile phone 100 stores the application execution log with the time at which the application is executed specified by the timer 202.

Thereafter, when the connection is established between the mobile phone 100 and the PC 200 for near field wireless communication at 15:30 through the communication module 201 and the connection processor 203, in the PC 200 as an initiator, the process selector 207 retrieves the log data from the log storage module 206, and the log request module 204 requests the mobile phone 100 as a responder for its log data.

In the mobile phone 100 as a responder, in response to the request for the log data received from the PC 200 as an initiator, the log response module 205 retrieves the log data from the log storage module 206, and responds to the PC 200 through the communication module 201.

In the PC 200 as an initiator, when acquiring the log data thereof and that of the mobile phone 100 as a responder, the process selector 207 selects an application to execute after the establishment of the connection based on the sets of the log data, and notifies the execution module 208 of the application. It is herein assumed that an application related to the most recent operation is selected. Specifically, the browser is executed on the PC 200 (five minutes before the establishment of the connection) more recently than photographing with the mobile phone 100 (two hours before the establishment of the connection) Thus, the process selector 207 selects, from the application association table illustrated in FIG. 5, execution applications associated with browser execution, i.e., an image capture application and an image transfer application, and notifies the execution module 208 of these applications.

Upon notified of the image capture application and the image transfer application by the process selector 207, the execution module 208 invokes the applications.

In this manner, when a connection to the mobile phone 100 is established for near field wireless communication after a map image or the like is displayed on the PC 200 with the browser, the image capture application and the image transfer application are invoked on the PC 200. Thus, after capturing the map image, the PC 200 can transfer the captured image (map image) to the mobile phone 100.

As described above, according to the first embodiment, when the connection processor 203 establishes a connection to a correspondent electronic device through the communication module 201 that controls the near field wireless communication device 104, the process selector 207 acquires at least either one of its own log data stored in the log storage module 206 or the log data of the correspondent electronic device. The process selector 207 selects an application to execute after the establishment of the connection based on the log data, and notifies the execution module 208 of the application. Upon notified of the application, the execution module 208 execute the application. This eliminates the need for the user to select an application or a content to execute before bringing the devices close together. Thus, the overall operation related to data transfer can be accomplished by only the intuitive operation of passing one device over the other. Accordingly, it is possible to improve the operability of the devices in the near field wireless communication system.

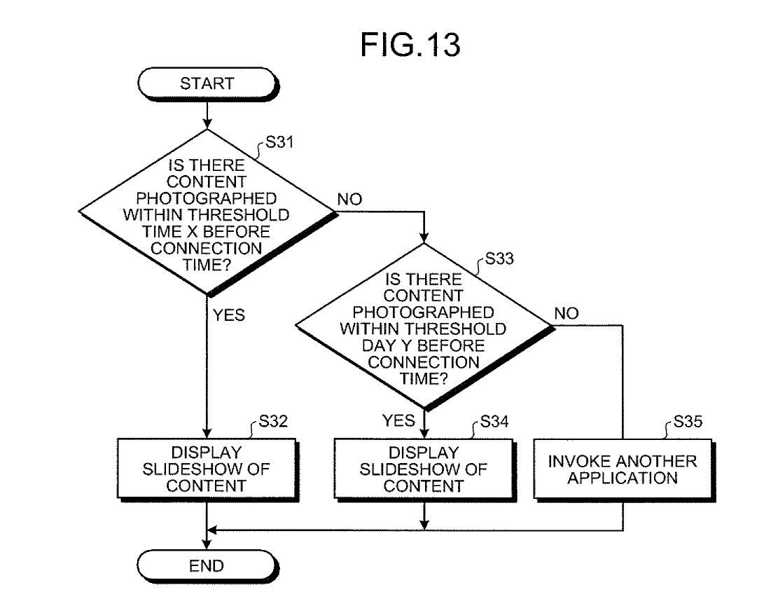

A second embodiment of the invention will be described with reference to FIGS. 13 to 15. In the following, constituent elements corresponding to those of the first embodiment are designated by like reference numerals, and their description will not be repeated.

As described above, the process selector 207 of the PC 200 as an initiator selects an application to execute after the establishment of a connection based on the log data, and notifies the execution module 208 of the application. It is herein assumed that an application related to the most recent operation is selected. For example, in the case illustrated in FIG. 6, the user takes a photograph with the mobile phone 100 (five minutes before the establishment of a connection) more recently than the execution of a browser on the PC 200 (two hours before the establishment of the connection). Thus, the process selector 207 selects, from the application association table illustrated in FIG. S, an execution application associated with a photo application, i.e., a slideshow application, and notifies the execution module 208 of the slideshow application.

In the first embodiment, the execution module 208 of the PC 200 as an initiator invokes the slideshow application notified by the process selector 207 (S18 in FIG. 9). In the second embodiment, the execution module 208 invokes an application in a different manner than in the first embodiment.

FIG. 13 is a flowchart of an application invoking process performed by the execution module 208 according to the second embodiment. As illustrated in FIG. 13, when the process selector 207 selects an execution application associated with a photo application, i.e., a slideshow application, and notifies the execution module 208 of the slideshow application, the execution module 208 determines whether there is a content captured or photographed within threshold time X before the connection time based on the log data (S31). The threshold time X may be, for example, 10 minutes. When there is a content photographed within the threshold time X before the connection time (Yes at S31), the process moves to S32. The execution module 208 acquires the content based on the log data, and invokes the slideshow application to display the content (S32).

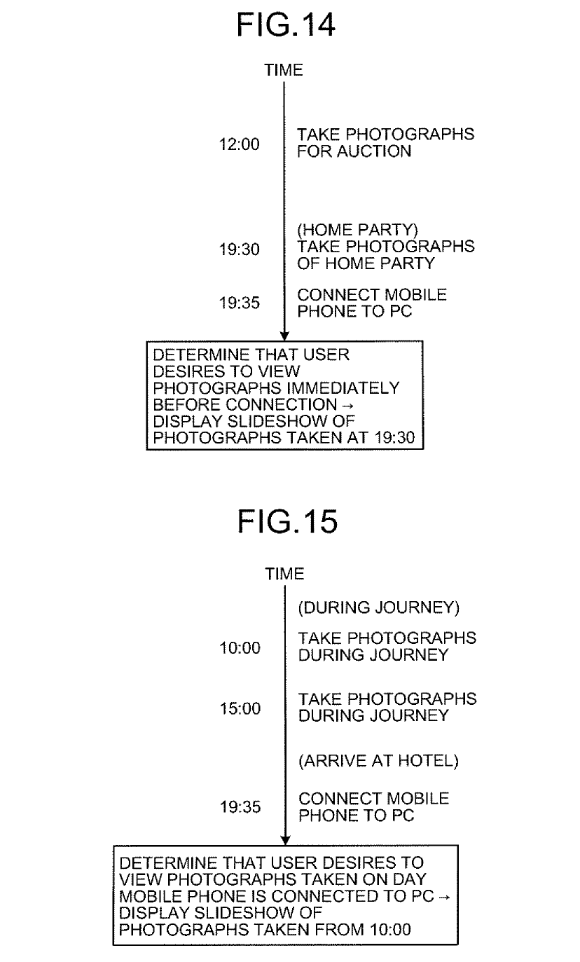

FIG. 14 illustrates an example in which a home party is held in the evening. In this example, the guests of the home party are photographed at around 19:30, and the mobile phone 100 used for the photographing is connected to the PC 200 in the home. By comparing the time at which the image is photographed with the connection time, the execution module 208 determines that the user intends to show a slideshow of the image on the PC 200 to enjoy it with the guests. Thus, the execution module 208 displays the photograph of the home party with the slideshow application rather than a photograph for auction taken at 12:00 on that day.

When there is no content photographed within the threshold time X before the connection time (No at S31), the process moves to S33. The execution module 208 determines whether there is a content photographed within threshold day Y before the connection time (S33). The threshold day Y may be, for example, one day. When there is a content photographed within the threshold day Y before the connection time (Yes at S33), the process moves to S34. The execution module 208 acquires the content based on the log data, and invokes the slideshow application to display the content (S34).

FIG. 15 illustrates an example in which images are taken with the mobile phone 100 at several places during a journey. In this example, a slideshow of these images is displayed on the PC 200 at the night after arrival at the hotel. Since there is no image taken immediately before the mobile phone 100 is connected to the PC 200, the execution module 208 determines that the user intends to view a slideshow of the images taken on the day during the journey. Thus, the execution module 208 displays only the images taken on the day with the slideshow application even if there is an image yet to be displayed.

When there is no content photographed within the threshold day Y before the connection time (No at S33), the process moves to S35. The execution module 208 switches the execution application to an application operating in the background without user operation as synchronizing an image stored in the PC 200 with an image stored in the mobile phone 100 (S35).

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device comprising:
a near field wireless communication device;
a communication module configured to control the near field wireless communication device to perform near field wireless communication;
a connection processor configured to establish a connection to a correspondent electronic device through the communication module;
a timer configured to record time related to execution of operations;
an execution module configured to invoke and execute applications;
a log storage module configured to store, when the execution module executes one of the applications, a log of execution of the application with execution time the application is executed specified by the timer as first log data; and
a process selector configured to acquire, when the connection processor establishes a connection to a correspondent electronic device through the communication module, at least one of the first log data stored in the log storage module and second log data of the correspondent electronic device, selects one of the applications to execute after establishment of the connection based on at least one of the first log data and the second log data acquired, and notifies the execution module of the application.

2. The electronic device of claim 1, wherein the process selector is configured to select, from the first log data and the second log data, log data indicating execution time closest to time specified by the timer at which the connection to the correspondent electronic device is established.

3. The electronic device of claim 1, wherein the execution module is configured to, upon being notified by the process selector of a slideshow application as the application to execute after establishment of the connection, determine whether there is a content captured within threshold time, and, when there is a content captured within the threshold time, invoke the slideshow application to display the content.

4. The electronic device of claim 1, wherein the execution module is configured to, upon being notified by the process selector of a slideshow application as the application to execute after establishment of the connection, determine whether there is a content captured within a predetermined time, and, when there is a content captured within the predetermined time, invoke the slideshow application to display the content.

5. The electronic device of claim 4, wherein the execution module is configured to, when there is no content captured within the predetermined time and there is a content captured within predetermined day, invoke the slideshow application to display the content captured within the predetermined day.

6. The electronic device of claim 5, wherein the execution module is configured to, when there is neither a content captured within the predetermined time nor a content captured within the predetermined day, invoke an application operating in background without invoking the slideshow application notified by the process selector.

7. A computer program product embodied on a computer-readable medium and comprising codes that, when executed on a computer, causes the computer to perform:
performing near field wireless communication;
establishing a connection to a correspondent electronic device;
recording time related to execution of operations;
invoking and executing applications;
storing, when one of the applications is executed, a log of execution of the application with execution time the application is executed recorded at the recording as log data;
acquiring, when a connection to a correspondent electronic device is established, at least one of the log data stored at the storing and log data of the correspondent electronic device; and
selecting one of the applications to execute after establishment of the connection based on the log data acquired.
